(19) United States
(12) Patent Application Publication
(10) Pub. No.: US 2006/0282762 A1
(43) Pub. Date: Dec. 14, 2006

(54) Collaborative document review system

(75) Inventors: David Lane Diamond, Mont Vernon, NH (US); Michael S. Rubino, Nashua, NH (US); Jeremy Lizt, San Francisco, CA (US)

Correspondence Address: PERMAN & GREEN, LLP, 425 POST ROAD, FAIRFIELD, CT, 06824, US

(73) Assignee: ORACLE INTERNATIONAL CORPORATION, REDWOOD SHORES, CA (US)

(21) Appl. No.: 11/150,055

(22) Filed: Jun. 10, 2005

(51) Int. Cl. G06F 17/24

(52) U.S. Cl. 715/511; 715/512

(57) ABSTRACT

The present invention is directed to collaborative document review. In one embodiment, the method includes creating a review version of an original document and storing the review document in a location that is simultaneously accessible by more than one reviewer, where each reviewer might be in a different location. Each reviewer is able to review at least one section of the review document and annotate, or comment on, the selected section of the review document. Once the annotation is created, the annotation can be posted and be immediately visible to each reviewer. Each reviewer can also provide further comment on any annotation. Annotations made in an earlier version of the review document can be retained and carried over into subsequent versions of the review document.

### BACKGROUND OF THE INVENTION

1. Field of the Invention

The present invention generally relates to document review and in particular to collaborative document review.

2. Brief Description of Related Developments

Document review processes utilized today generally suffer from a number of key problem areas including, for example, redundant reviewing and reporting, issue tracking, error logging, missing context, feedback conflicts, and approval collection.

Redundant reviewing and reporting typically occurs when a document is put out for review and multiple reviewers are asked to review the same sections of text. In many cases, the reviewers will identify the same issues in the text without knowledge of each other's activities and comments. Reporting documentation issues can be expensive, as the time required to formulate thoughts, fact-check corrections, provide alternate wording, and physically report the comment can quickly add up. Redundant reporting can involve a substantial waste of time affecting both the reviewers and the document owner(s).

It can also be very difficult for a reviewer to track the issues and feedback provided on a document, for two basic reasons. First, there is no good mechanism to track when feedback is incorporated into a subsequent version of the document. A reviewer often does not know whether it is necessary to re-report the issue in the subsequent version or simply wait for a later version of the document. Second, even if the feedback has been incorporated, the reviewer is usually forced to cross-reference their own feedback against the new document in order to find and validate the modification or “fix”. This is a very time-consuming endeavor, often leading to the reality that many reviewers do not validate relevant fixes.

Also, issues in a document, and the corresponding feedback, can often be taken out of context. Reviewers would often prefer to print out a piece of documentation and hand-write comments in the margins adjacent to the relevant text. However, the shortcomings of this approach (e.g. it requires physically delivering a copy of the document to the writer and does not facilitate sharing or tracking of feedback) sometimes discourages this type of review. Reviewers may enumerate comments in a separate document. These alternative methods take the comment away from its relevant context.

Additionally, feedback conflicts can occur between different reviewers. Since reviewers cannot easily or readily see the comments made by earlier reviewers, they provide their own feedback on a particular issue, which may or may not concur with earlier comments. Whether the reviewer(s) feedback conflicts as a result of differing opinions or simply miscommunication, it is usually left to the writer (also referred to herein as the “document owner”) or individual responsible for the overall review to sort out the various feedback inputs and comments. Resolving review comment conflicts can be difficult and time consuming. While it is often preferable for the reviewers to resolve the conflict between and among themselves, there is no good mechanism to facilitate this type of interaction.

Furthermore, approval collection can be difficult when dealing with a plurality of reviewers. It is often a challenge for the document owner(s) to secure meaningful approvals from each of their reviewers. Reviewers may sometimes be negligent in returning an approval or disapproval, or even give an approval without having performed an adequate review. With a plurality of reviewers, it can be difficult to centrally track approvals and review comments. A reviewer may be more inclined to perform a quality review and give a more honest approval if their comments and sign-off are easily viewable by the team and document owner.

Solving these issues demands a collaborative application that enables reviewers to put reviews directly into context of the version of the document under review and to be able track those revisions and reviews easily, even as the content of a document changes.

### SUMMARY OF THE INVENTION

The present invention is directed to collaborative document review. In one embodiment, the method includes creating a review version of an original document and storing the review document in a location that is simultaneously accessible by more than one reviewer, where each reviewer might be in a different location. Each reviewer is able to review at least one section of the review document and annotate, or comment on, the selected section of the review document. Once the annotation is made, the annotation can be posted and be immediately visible to each reviewer. Each reviewer can also provide further comment on any annotation. Annotations made in an earlier version of the review document are retained and can be carried over into subsequent versions of the review document.

In another aspect, the present invention is directed to web-based document review. In one embodiment the method comprises accessing a document to be reviewed through a web-accessible application, selecting a section of the document to comment on, entering a comment into an annotation field, and posting the annotation field wherein the comment is immediately and simultaneously visible and accessible to any other reviewer of the document.

### BRIEF DESCRIPTION OF THE DRAWINGS

The foregoing aspects and other features of the present invention are explained in the following description, taken in connection with the accompanying drawings, wherein:

FIG. 1 is a block diagram of one embodiment of a system incorporating features of the present invention.

FIG. 2 is illustration of a document under review in a system incorporating features of the present invention.

FIG. 3 is a flowchart of one embodiment of a method incorporating features of the present invention.

FIG. 4 is an illustration of one embodiment of a method of collaborative review of a document in a system incorporating features of the present invention.

FIG. 5 is a block diagram of one embodiment of an architecture that can be used to practice the present invention.

FIG. 6 is an illustration of an application of one embodiment of the present invention to a word processing application.

FIG. 7 is an illustration of a tabular form of annotation details from the annotations shown in FIG. 6.

### DETAILED DESCRIPTION OF THE PREFERRED EMBODIMENT(s)

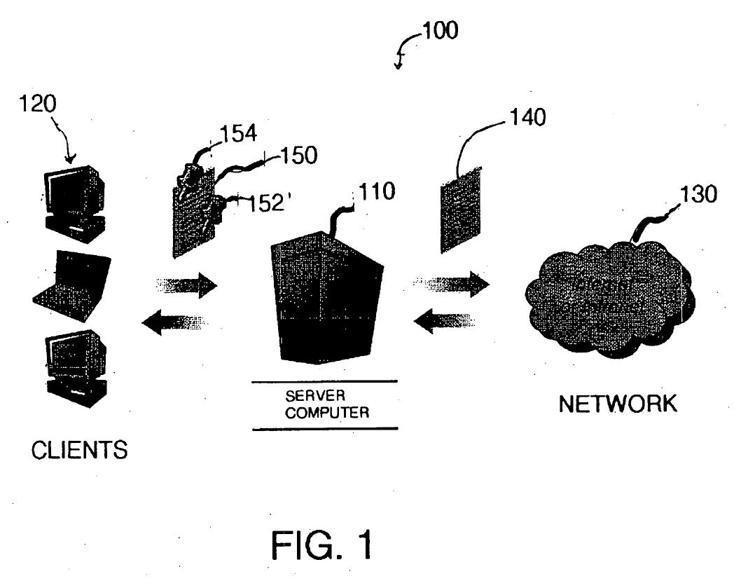

Referring to FIG. 1, a perspective view of a system 100 incorporating features of the present invention is illustrated. Although the present invention will be described with reference to the embodiment shown in the drawings, it should be understood that the present invention can be embodied in many alternate forms of embodiments. In addition, any suitable size, shape or type of elements or materials could be used.

The present invention generally provides for web-based or server based collaborative document review. Reviewers are able to review a document simultaneously and collaboratively, even though each reviewer may be located remotely from another reviewer or the document owner. As a reviewer makes comments on a particular section or portion of the document, the comments, also referred to herein as “annotations” are added or inserted directly into the context of the document under review. The annotations can be immediately visible, in context, to all participants of the review. Each reviewer can respond to any particular annotation with an additional comment that will also be posted. As the document review process continues and a document is modified, the annotations can be carried over into a subsequent version of the document. In this fashion, the present invention allows the document owner to generate a revised document without having to address each comment or all of the “feedback” on the prior document, in the next revision.

Referring to FIG. 1, one embodiment of a system 100 incorporating features of the present invention is illustrated. The system 100 generally comprises a computer system or server 110, clients 120 and a network 130, such as for example the world wide web (“WWW”), the Internet or an intranet.

When a document is set to be reviewed, a review copy 150 of the original document 140 is created and uploaded, for example, to a web site or uniform resource locator (“URL”) address. To access the review copy 150 of the document, any one of the reviewers 120 can go to the URL and view the web page that includes the review document 150. Each reviewer can review and annotate the review copy 150, simultaneously. All the reviewer(s) 120 needs to access the review document 150 is a standard web browser application. In this embodiment, client software is not required to access and annotate the review document 150. The annotations, marked as 152 and 154, to the document 150 are written to a database in for example, the server 110. The original document 140 can be stored on an origin server. As shown in FIG. 1, the server 110 obtains the original document 140 from the origin server and serves up the review document or version 150 to the reviewers 120. In an alternate embodiment, the original document 140 can be stored separately from where the review document 150 is stored.

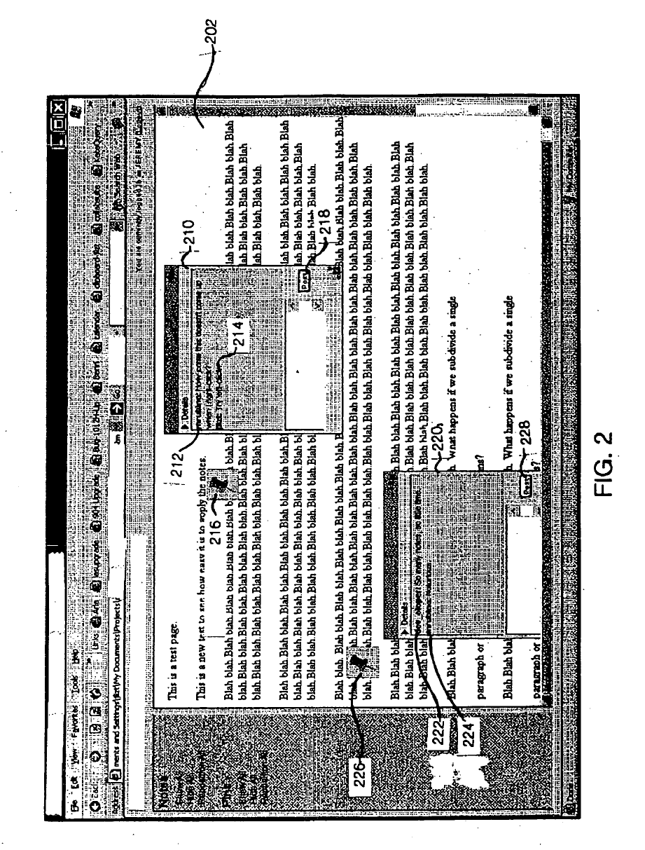

In order to annotate, comment on or suggest a change to a section of the review document 150, the reviewer 120, selects a portion or section of the document 150 to annotate. For example, referring to FIG. 2, a section 202 of a document under review is illustrated. It is noted that the section 202 is merely a screen shot of the entire document. The scroll bars 203a and 203b can be used in the known fashion to view other portions or sections of the document. Other aspects of the particular application associated with the document under review are not described herein, it being understood that the present invention can be applied to any particular program that includes reviewable content.

The section 202 includes a number of textual sentences and paragraphs. Generally, these are referred to as “sections” herein. In alternate embodiments, the section 202 could include any suitable content that can be reviewed. In order to annotate a section of the document, the reviewer positions a cursor, or other pointing device, at or near a desired location within the section 202. The reviewer can then select a comment or annotation location, by for example, “clicking” a mouse or other cursor type device. Once selected, an annotation box 210 could be displayed on the screen area of the particular display to indicate that the annotation selection option has been activated. In alternate embodiments, any suitable indicator can be utilized to indicate to the reviewer that the annotation function has been activated. A comment or annotation is generally a textual note made in reference to a particular section of the target, or review document. A user generally creates a comment via the embedded view of a review.

As shown in FIG. 2, the annotation input screen 210 appears in an area that is near the selected point 216 for the annotation. In alternate embodiments, the annotation input screen can be displayed at any desired location on the user interface. The reviewer can the input or enter the desired commentary 212 in the box 210. For example, as shown in FIG. 2, the reviewer “mrubino” has inputted the comment 212 “How come this doesn't show up when I right-click?”

Once the comment 212 is entered, the reviewer can activate or select “Post” 218 to post the annotation so that it is displayed in context with the document under review and is made available to all of the other reviewers. Once the annotation 212 is “posted” an icon 216 is shown at or near the location of the annotated section. As shown in FIG. 2, the posted annotation 216 is represented as a “pushpin”, although in alternate embodiments any suitable or desired icon can be used, other than including a pushpin. The icon 216 will be visible to the other reviewers. It is a feature of the present invention that all annotations made to the review copy 202 are immediately viewable by all reviewers of the document.

A reviewer desiring to view the annotation associated with the icon can select the icon 216. Once the icon 216 is selected, the annotation screen or box 210 will be displayed with the annotation line 212, together with any other comments made in connection with the annotation. For example, as shown in FIG. 2, another reviewer “jlizt” has replied to the initial comment 212 with the comment 214 “Try left-click.” The reply 214 has also been posted 218 so it too is viewable by the other reviewers. In this fashion, an ongoing electronic discussion can ensue in reference to a particular comment. The “discussion” could be in real-time, such as for example instant-messaging, or replies could be ongoing, such as for example a reply to an email message.

Similarly, the reviewer “mrubino” in FIG. 2 can also review other annotations posted in the review document. For example, referring to FIG. 2, icon 226 represents an annotation posted by some other reviewer other than the reviewer “mrubino”. The reviewer “mrubino” in this example can highlight or select the icon 226, by for example, “clicking” on it. The annotation log 220 will appear on the display or screen. The annotation log 220 will display all comments made in relation to the section. In this example, a prior annotation 222 has been posted, by “dev₁₃eloper” that reads “So many notes, so little time”. The reviewer “mrubino” can review this annotation and post another annotation 224 in response, if desired. In this example, the reviewer “mrubino” has posted the reply comment 224 “Notorious”. The comment 224 is typed in and the Post button 228 is selected to enter the comment, in which case the annotation 224 is posted for all reviewers to see.

In the event that another reviewer posts another annotation, or responds to a prior annotation, that comment can be immediately seen after it is posted by the other reviewer.

The icons 216 and 226 shown in FIG. 2 are markers that generally correspond to an approximate location of the area that is associated with the comment 210 and 220, respectively. A comment, such as 210 and 220, posted by the reviewer is “attached” or “anchored” to a particular section of the document or HTML text. Text documents are supported by rendering the text documents into an HTML format by inserting appropriate HTML tags around and inside the text as appropriate. It is a feature of the present invention to place and view comments directly in context. For example, referring to FIG. 2, the reviewer has accessed the target document 202. The reviewer moves the cursor to a desired section of the document and selects the “annotate” option or function, which causes the comment or annotation box 210 to appear. The reviewer can then enter the desired comment 212. When the comment is posted by selecting the “Post” function 218, a push pin 216 appears at the corresponding location of the document. Another reviewer coming into the target document can see the annotation 210 and read the comment 212. This other reviewer can also add a comment 214 to the original comment 212. The push pin 216 follows the text even if the text moves.

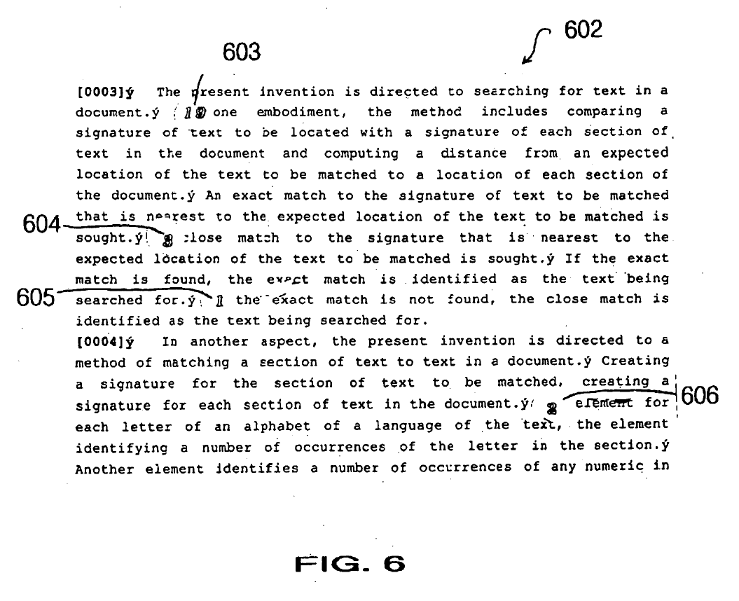

Although the icons 216 and 226 in FIG. 2 are shown as graphic images, as noted above, the icons 216 and 226 can comprise any suitable markers, images or graphics. For example, referring to FIG. 6, the annotation indicators or markers could comprise numbered icons 603-606. As shown in FIG. 6, during a review of the document section 602, four annotations, numbered as 19, 3, 1 and 2, were applied to the section 602. In the example of FIG. 6, the annotation icons comprise a circle with a corresponding number inside. In alternate embodiments, any suitable image can be incorporated. Annotations 19 (603), 3 (604) and 1 (605) are anchored or connected with the paragraph numbered 0003. The annotation 2 (608) is anchored with a subsequent paragraph numbered 0004.

In one embodiment, the icons representing an annotation could include a specific indicator of the status or priority of a particular annotation. For example, referring to FIG. 2, a color of the push pin 216, 226 could change to note a change in status of the review or annotation. If the annotation has not been read by the author, it could be one color. If the annotation has been read and requires further action or response, it could be another color. If the annotation is assigned to another person for response, suitable colors could indicate the assignment.

For example, in one embodiment, a status assigned to a push pin, or annotation icon, could include, Open, Working, Review, or Closed. “Open” indicates a new annotation, “Working” indicates someone is working on an issue associated with the annotation, “Review” indicates that the issue is resolved but other must concur before the issue can be considered closed, while “Closed” indicates that the annotation has been reviewed, accepted or rejected. Each status can be represented by a different color, pattern or even a different icon. The colors, shapes, patterns, icons and change possibilities are only limited by the different status possibilities of each annotation. The priority of the annotation could also be represented by a color or symbol. In one embodiment, the symbol or type of icon might be symbolic of the annotation status, priority or other information. Generally, any suitable icon or representation can be used.

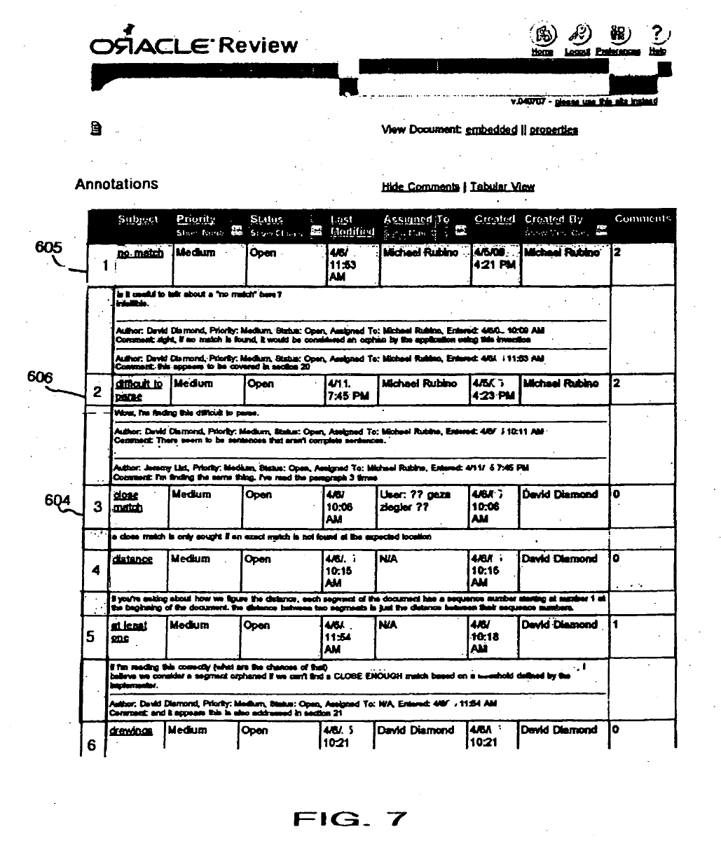

For review purposes, a list of annotations can be generated that includes the annotation number or identifier and the corresponding comments and other information. FIG. 7 illustrates one embodiment of a tabular view of the comments and other information associated with the annotations shown in FIG. 6. The numbered icons are listed on the left hand side of the table, followed by the subject of the annotation, its priority, the status, the last modified date, who the annotation is assigned to, when the annotation was created, who the annotation was created by, and the number of comments associated with the annotation. In alternate embodiments, any suitable information can be associated with an annotation and the annotations can be presented in any suitable format.

The annotations shown in FIGS. 2 and 6 for example, can remain in context with the document under review, even if the document under review is modified. The original annotations can be retained with the document over subsequent revisions. Thus, the document owner can issue a revision of the reviewed document even though all of the comments and annotations have not been reviewed or addressed.

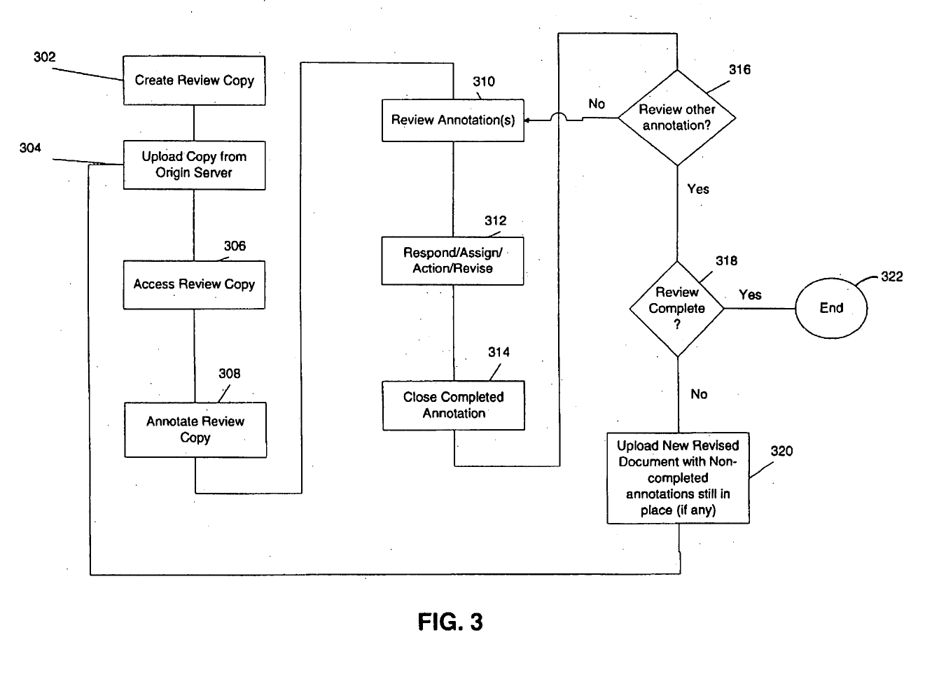

Referring to FIG. 3, one embodiment of a method incorporating features of the present invention is illustrated. In one embodiment, the author of the document creates a review copy 302 of the original document. The author identifies the document to be reviewed and sends 304 the URL of the review document to the other reviewers. Each reviewer accesses 306 the review copy and make 308 suitable annotations, including new comment, responding to other comments or addressing assigned subjects. The author can review 310 all comments, either collectively or even as they are posted. The author can respond to, reassign, take suitable action, or even revise the review copy in order to address each comment as needed. It should be noted that not all annotations require a response. Some annotations may merely be commentary that once reviewed by the document owner, can be closed out 314.

After the author reviews all the comments and makes any desired changes, the author can “close” the annotation 314. The “push pin” or other icon or image representation on the closed annotation could then be removed from the view. In some instances it may be desireable for a user to see a “closed” annotation. Therefore, the user can choose whether “closed” annotations are displayed or removed from the display.

The author can decide whether to review 316 any other annotations that may not have yet been reviewed. Alternatively, the author can revise the document if needed and resubmit 320 a new revision to the reviewers for further review, if the review is not complete 318. It is noted that any annotations that were not closed 314 by the author in the prior review, will be carried over into the subsequent revision that is posted 320. If all the annotations are closed out and the review is complete, the review can be considered complete 322. If other annotations remain to be reviewed, the process can return back to step 310.

Generally, all comments belong to a single review. The annotations or comments to a document are stored together with their anchor data. Anchor data is technical data that facilitates the association of the comment with the related section of the target document. The anchor data enable the annotations to be attached back to the corresponding content even if the content of the document has changed or moved. One example of a method and system for matching text at an expected location is described in U.S. patent application Ser. No. ______, filed on ______, 2005 entitled “FUZZY MAATCHING OF TEXT AT AN EXPECTED LOCATION”, commonly owned by the assignee of the instant application, the disclosure of which is incorporated herein by reference in its entirety.

For example, in some instances, as an author is reviewing an annotation, the author might also make corresponding changes to the text, by adding or deleting text. The “anchor data” that is associated with an annotation, is generally logged in a database and points to a specific location in the document. However, if the text of the document changes, the actual location of the annotation may also change. This change might not be reflected in the database and the annotation icon will not necessarily correspond to the section of text to which it was originally associated. It is a feature of the present invention to reposition an annotation to its corresponding location in the text of the document, if the text of the document changes.

The positioning and repositioning of an annotation in a document generally comprises computing a signature for each section of the text, and comparing the computed signatures to the original signature of the section of text to which the annotation belongs. If an exact match is found that is near an expected location of the annotation, the location of the exact match becomes the new location for the annotation. However, if an exact match cannot be located, the next best match is sought that is nearest to the expected location of the annotation. The section of the changed document that is close enough in signature and close enough in distance to the expected location of the annotation, becomes the new anchoring point for the annotation.

If the change to the document is too extensive and a close match cannot be identified, in one embodiment the annotation icon can be relocated to a document annotation section within the frame of the document page.

The present invention allows text in a document to be located even if other text is added or deleted from the document. In one embodiment this includes creating a signature for the text that needs to be matched and a signature for each section of text in the document being searched. In one embodiment, a signature can be made up of, for example, 28 elements, one for each letter of the alphabet, one for any numeric character and one for any separator (e.g. space, tab). In alternate embodiments, the signature can be made up of any suitable number of elements. For example, referring to FIG. 2, a section of text 202 is shown with a corresponding signature 204. The signature includes twenty-eight elements. Each section of the document will have a unique signature. The section in this example is defined as a paragraph beginning with a reference number and ending with a period. In alternate embodiments, any suitable or desired parameters can be defined for a start and an end of a section. A section can be any user defined parameter. A section does not have to be a whole sentence or paragraph, and can rely for example on tags to identify and separate sections. A section will then be based on the beginning and ending of tags. The section can be based on whatever bread-up the user desires so that a section can compute and relocate its position within a document.

The moving of an annotation, for example, in a cut and paste operation, discards the old signature and takes the signature of the section to where it is moved. The annotation is re-applied and re-anchored. The anchoring includes the signature of the section to which the annotation is anchored as well as the location of the section where the annotation is expected to be.

Referring again to FIG. 2, in one embodiment, an annotation 220 could become a discussion within a document 202. For example, the reviewer can post a comment 212 which is immediately viewable by all other reviewers. Other reviewers could “respond” or post another comment 214. Since the response comment 214 is also immediately viewable, a “discussion” could ensue within the context of a document. In essence, a “chat room” as that term is commonly known and defined, can be created around, or comprises, an annotation. The term “annotation”, as used herein, represents an attachment to the review document. A chat room or other such “online” or electronic discussion could be considered a type of annotation.

In another embodiment, an annotation could become the source of an online, live discussion, with comments as threads, or hierarchical threading. Similarly, in one embodiment, multiple discussions within the content of annotations could be taking place at the same time. For example, referring to FIG. 2, annotations 210 and 220 could comprise the source of concurrent, ongoing, online discussions. It is a feature of the present invention to enable multiple “chat rooms” within the content of a single document. In alternate embodiments, generally any type of collaborative entity can be created within a document. For example, a “poll” or recorded meeting summary” could be inserted at any point within the document.

In one embodiment, an annotation could include an option enabling a comment to be assigned to a particular individual or individuals for action or response. When the assign option is selected, an email notification can be provided to the assignee advising of the assignment.

Notes and annotations can also be arranged as a list for review, including lists for “orphaned” annotations, or annotations for which a close match cannot be determined. A “close match” can be a factor of the correspondence in signatures and the proximity in distance of the close match to the expected location of the text. A close match might be a section of text that has an identical signature to the text to be matched that is nearest to the expected location of the text. A close match might also include a section of text that has a signature that is comparatively similar to the signature of the text to be matched and is nearest to the expected location of the text. When a close match is not found the search for the section of text to be matched unsuccessful and the annotation is considered “orphaned” by the application. This can be an appropriate state for text that has been altered beyond recognition.

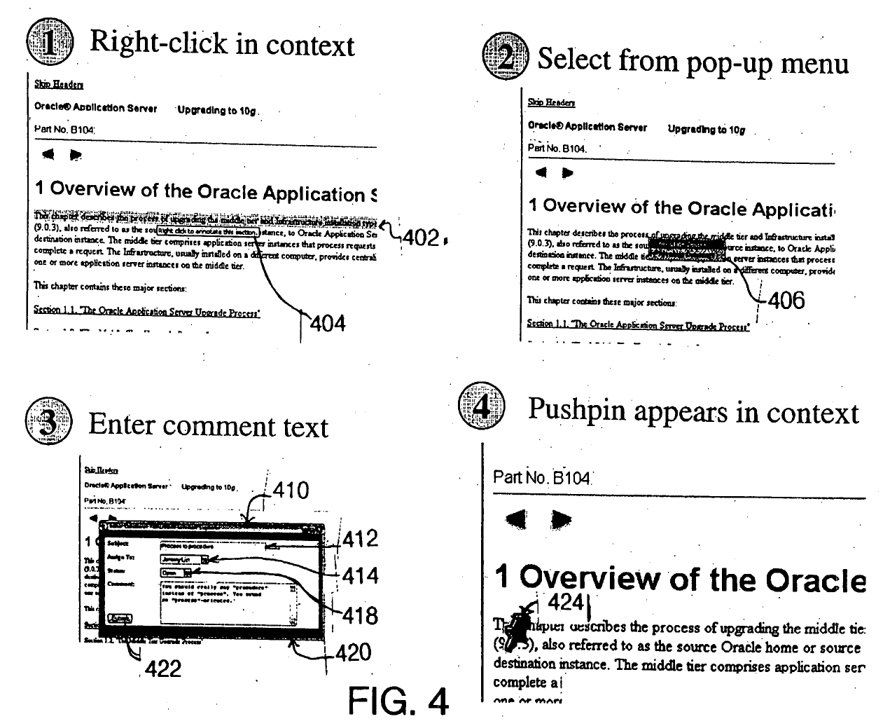

Referring to FIG. 4, another illustration of a method incorporating features of the present invention is shown. The reviewer has selected 402 a portion of text to be annotated. A menu option 404 can be displayed that instructs the reviewer to “right click” to annotate the selected section 402. When the reviewer “right clicks” the mouse or cursor device, a menu option 406 can be displayed that allows the reviewer to choose between annotating the selected section 402 or the document. The menu 406 can appear as a pop-up menu.

If the reviewer selects to annotate, an annotation box 410 displayed that allows the reviewer to enter comment text. The annotation box 410 can include for example, a section 412 for a subject, a section 414 for assigning the comment to another party for action, a section or box 418 to indicate the status of the comment, and a section 420 in which the review can enter the comment. In alternate embodiments attributes other than including subject, assignee, status or comment can be included. For example, one attribute could be “priority” information.

Once the reviewer is finished entering the comment, the reviewer can post 422 the comment. Upon posting the comment, an annotation icon 424 will appear in context of the document.

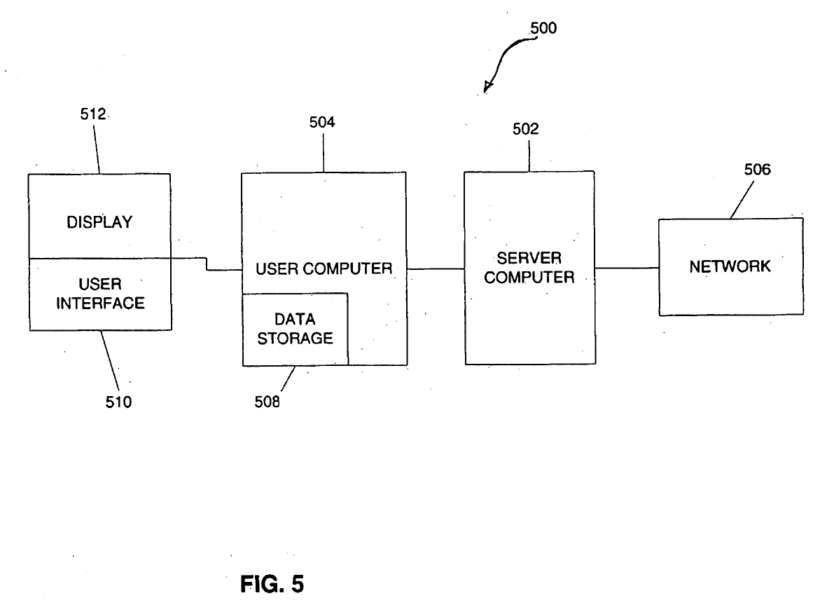

The present invention may also include software and computer programs incorporating the process steps and instructions described above that are executed in different computers. In the preferred embodiment, the computers are connected to the Internet. FIG. 5 is a block diagram of one embodiment of a typical apparatus 500 incorporating features of the present invention that may be used to practice the present invention. As shown, a computer system 502 may be linked to another computer system 504, such that the computers 502 and 504 are capable of sending information to each other and receiving information from each other. In one embodiment, computer system 502 could include an origin server or computer adapted to communicate with a network 506, such as for example, the Internet or an Intranet. Computer systems 502 and 504 can be linked together in any conventional manner including a modem, hard wire connection, fiber optic link or such other suitable network connection. Generally, information can be made available to both computer systems 502 and 504 using a communication protocol typically sent over a communication channel or through a dial-up connection on ISDN line. Computers 502 and 504 are generally adapted to utilize program storage devices embodying machine readable program source code which is adapted to cause the computers 502 and 504 to perform the method steps of the present invention. The program storage devices incorporating features of the present invention may be devised, made and used as a component of a machine utilizing optics, magnetic properties and/or electronics to perform the procedures and methods of the present invention. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 502 and 504 may also include a microprocessor for executing stored programs. Computer 502 may include a data storage device 508 on its program storage device for the storage of information and data. The computer program or software incorporating the processes and method steps incorporating features of the present invention may be stored in one or more computers 502 and 504 on an otherwise conventional program storage device. In one embodiment, computers 502 and 504 may include a user interface 510, and a display interface 512 from which features of the present invention can be accessed. The display interface 512 and user interface 510 could be a single interface or comprise separate components and systems. The user interface 508 and the display interface 512 can be adapted to allow the input of queries and commands to the system, as well as present the results of the commands and queries.

The present invention provides for collaborative document review utilizing for example, a web-based browser application, that allows for real-time review of a document by multiple reviewers, where comments and feedback can be seen and addressed be each reviewer prior to completion of the review. The document owner can thus collect complete review information in a single review process. Annotations to the document are immediately visible to each reviewer for further action and comment. As a document is revised by the owner, annotations made in an earlier version of the review document that are not closed out are retained, and can be carried over into subsequent versions of the review document.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of collaborative document review comprising:
creating a review version of an original document and storing the review version in a location that is simultaneously accessible by at least one reviewer from more than one location;
enabling a selection of at least one section of the review version by the at least one reviewer;
enabling an annotation of the selection by the at least one reviewer; and
posting the annotation in connection with the selection, wherein the annotation is immediately visible to the at least one reviewer.

2. The method of claim 1 further comprising, after creating the review version, uploading the review version to a URL address and transmitting the URL address to each of the at least one reviewer.

3. The method of claim 1 further comprising associating an annotation to a section of the review version by:
creating a signature for the section of the review version; and
associating a location of the signature with the annotation, wherein the annotation remains with the location of the signature if a content of the review version.

4. The method of claim 3 further comprising repositioning the annotation to a new location of the section of the review version by:
calculating a signature of the section appearing at a location originally associated with the annotation;
determining if there is an exact match between the signature of the section associated with the annotation and the signature of the section at the location originally associated with the annotation; and
if there is not exact match, determining if there is at least one close match between the signature of the section associated with the annotation and the signature of the section at the location originally associated with the annotation.

5. The method of claim 4 further comprising, if the at least one close match is found:
calculating a distance between an expected location of the signature of the section associated with the annotation and each of the at least one close match; and
associating the annotation with a location of the at least one close match that is closest in distance to the expected location of the annotation.

6. The method of claim 4 further comprising determining if there is at least one close match by comparing the signature of the section associated with the annotation with a signature of each section of the review version by:
computing a sum of part scores in each section of the review version;
comparing the computer sum of part scores of each section with a sum of part scores of the section associated with the annotation; and
identifying an acceptable close match on a basis of the computer part scores.

7. The method of claim 1 further comprising providing a reviewer comment area in the annotation and an area for an author response to the reviewer comment.

8. The method of claim 1 further comprising creating the review version by uploading a copy of the original document as a web page having a uniform resource locator (URL) address, wherein the review version can be accessing by going to the URL.

9. The method of claim 1 further comprising the review version being a web-accessible document accessed through an Internet browser.

10. The method of claim 1 further comprising accessing the review version through an Internet browser without any additional client software.

11. The method of claim 1 further comprising storing the annotation created by one of the at least one reviewer in a database and storing anchor data related to the annotation that enables the annotation to be attached to its content.

12. The method of claim 11 further comprising storing the annotation separately from the document itself.

13. The method of claim 1 further comprising responding to a comment in an annotation by providing another comment within the annotation.

14. The method of claim 1 further comprising posting multiple annotations with the review document, each annotation comprising a live discussion between reviewers regarding a corresponding annotation.

15. The method of claim 1 further comprising repositioning the annotation from an original location to a new location after revisions to the review document by determining a match that is close enough in signature and distance to an expected location of the annotation.

16. The method of claim 15 where the repositioning further comprises comparing a signature of text to be located with a signature of each section of text in the document;
computing distance from an expected location of the text to be matched to a location of each section of the document;
finding an exact match to the signature of text to be matched that is nearest to the expected location of the text to be matched;
finding a close match to the signature that is nearest to the expected location of the text to be matched; and
wherein if the exact match is found the exact match is identified as the text being searched for, or if the exact match is not found, the close match is identified as the text being searched for.

17. The method of claim 16 wherein the comparing of the signature of the text to be located with the signature of each section of text in the document comprises:
computing a sum of part scores in each section of the document;
comparing the computed sum of part scores of each section with a sum of a part score of the text to be matched; and
identifying an acceptable close match on a basis of the comparison of the computed part scores.

18. The method of claim 16 wherein a signature comprises a series of twenty-eight elements, including one element for each letter of the alphabet, one element for any numeric character and one element for any separator character.

19. The method of claim 1 further comprising assigning an action associated with the annotation to another reviewer and automatically generating an email notification to the another review upon posting the annotation.

20. The method of claim 1 further comprising calculating a signature associated with the section being annotated and storing the signature as anchoring data separate from the annotation.

21. A method of web-based document review comprising:
accessing a web-accessible document to be reviewed;
selecting a section of the document to comment on;
entering a comment into an annotation field; and
closing the annotation field wherein the comment is immediately and simultaneously visible to any other reviewer of the document.

22. The method of claim 21 further comprising using an Internet-browser to access the document without any additional client software.

23. The method of claim 21 wherein the document comprises an html document.
